(19) United States
(12) Patent Application Publication
(10) Pub. No.: US 2024/0399613 A1
(43) Pub. Date: Dec. 5, 2024

(54) STAINED WOOD AND METHODS OF DRYING AND STAINING WOOD

(71) Applicants: Alta Forest Products, LLC., Chehalis, WA (US); Standard Paints, Inc., Mansfield, TX (US)

(72) Inventors: Alexandra Rose GLODICH, Fort Worth, TX (US); Brent Price TURNER, Midlothian, TX (US); James Christopher VENTERS, Chehalis, WA (US); Joseph Reese PENROD, Chehalis, WA (US); Michael J. CAULK, Chehalis, WA (US); Christopher Todd STEEN, Haslet, TX (US)

(21) Appl. No.: 18/680,571

(22) Filed: May 31, 2024

Related U.S. Application Data
(60) Provisional application No. 63/506,008, filed on Jun. 2, 2023.

(51) Int. Cl. B27K 5/02; B27K 5/00; F26B 25/22

(52) U.S. Cl. CPC B27K 5/02; B27K 5/001; F26B 25/22; F26B 2210/16

(57) ABSTRACT

A method of drying and staining wood includes feeding green wood with a varying moisture content into an oven and drying the green wood in the oven. The residence time of the green wood in the oven and the temperature of the oven are selected according to a time and temperature profile based on a pre-drying moisture content of the green wood to produce dry surface wood having a moisture content of approximately 15% or less at the dry surface. The method further includes conveying the dry surface wood to a stain booth and staining all sides of the dry surface wood directly following the drying. A system for performing the method and a stained wood product produced according to the method are also considered.

### BACKGROUND

### Technical Field

The present disclosure generally relates to stained wood and related methods of drying and staining wood.

### Description of the Related Art

Certain stained wood products and methods of drying and staining wood are known. One particular application of such technology is for drying and staining wood fence boards. A user may buy fence boards from a supplier or store and install the boards as part of a fence. The fence boards that are available to consumers are typically “green” fence boards that have recently been cut from a tree and often have a moisture content around 20%-40%. As such, the boards must be dried before stain is applied, preferably to a moisture content of 15% or less for most stains, to ensure proper stain adsorption and uniformity. One solution to this issue is to install the boards as part of the fence and leave the boards to dry in the natural environment until an internal moisture content of the boards is suitable for the application of stain. Such an approach is better suited to hot and arid environments and can be challenging in regions with high humidity, significant rainfall or precipitation, or both, that slow the natural drying process. In some regions, natural drying at the installation location of the fence boards is only practical in certain seasons.

In some cases, fence boards are shipped to a hot, arid environment for natural drying outdoors before the boards are stained, stacked, and shipped to be sold to consumers as pre-stained boards. However, this process is time consuming and expensive. Even in ideal conditions, the drying process to reduce the moisture content of green fence boards to a level suitable for application of stain can take weeks. Shipping the boards to and from the hot, arid environment also significantly increases costs. An alternative solution is to dry the green fence boards in a kiln from the initial moisture content to the preferred 15% or less moisture content before staining and shipping to consumers. This process is also expensive and time consuming, particularly on a larger scale for commercial production of fence boards. For example, typical kiln drying time may be performed in multiple stages and for periods of time of at least 8-10 minutes in each stage along with rest periods of several minutes between the stages. Special care is taken to dry the wood at particular temperatures to avoid splitting the green fence boards or burning the boards during the drying process. The above deficiencies and disadvantages of known technology applies equally to all types of stained wood, and not just fence boards. Thus, current technologies are not always suitable for production of pre-stained wood in certain environments and it would be advantageous to have stained wood products and methods of drying and staining wood that overcome the disadvantages of known technologies.

### BRIEF SUMMARY

The present disclosure generally relates to methods of drying green wood to lower a surface moisture content of the wood to a suitable level for application of stain, followed immediately by application of stain to produce pre-stained wood in less time and at lower overall cost. Once the stain is applied, the wood releases remaining internal moisture naturally through the stain over time.

In more detail, green wood may initially have a varying moisture content based, at least in part, on a species of the green wood and the depending on the season and location in which the wood was initially cut along with the ambient humidity in which the green wood is stored. A time and temperature profile for drying green wood with varying moisture content can be developed based on these and other factors. In a non-limiting example, green wood with a higher initial moisture content may be dried for a longer period of time and/or at higher temperature than green wood with a lower initial moisture content based on the above. The green wood resides in the oven for a period and at an oven temperature according to the time and temperature profile to produce dry surface wood with a moisture content at the dry surface of approximately 15% or less that is suitable for application of stain. In other words, the residence time in the oven and temperature of the oven are varied based on the initial moisture content of the wood to produce the dry surface wood. The drying may occur in a single, continuous processing step with the internal portion of the wood generally having a moisture content of approximately 15% or more after the drying. In one non-limiting example, the stain may be applied to all sides of the board directly after, or soon after, the drying step. This is done by placing the dry surface wood into the staining booth immediately after it leaves the drying oven. With this process, the stain is able to wet the surface of the board and adsorb onto the dry surface wood before the dry surface wood is able to take in moisture from both the interior of the board and from the surrounding air. The stained boards release internal moisture over time, even after the wood is installed in its final location.

In one or more embodiments, a method of drying and staining wood may be summarized as including: feeding green wood with a varying moisture content into an oven; drying the green wood in the oven according to a time and temperature profile that is based on a pre-drying moisture content of the green wood to produce dry surface wood having a moisture content of approximately 15% or less at the dry surface; and staining the dry surface wood following the drying.

In an embodiment, the drying of the green wood may be a single, continuous processing step.

In an embodiment, the time and temperature profile varies depending on one or more of a species of the green wood, ambient humidity in which the green wood has been stored, and the pre-drying moisture content of the green wood entering the oven.

In an embodiment, the moisture content of the dry surface wood is measured at an outermost surface of the dry surface wood.

In an embodiment, the moisture content at the outermost surface of the dry surface wood is measured with a pin meter resting under its own weight on the outermost surface of the dry surface wood.

In an embodiment, the internal moisture content of the dry surface wood is greater than approximately 15% after the drying, as measured by a pin meter inserted at least 0.08 inches into the wood.

In an embodiment, the drying of the green wood includes determining the pre-drying moisture content of the green wood based on a humidity content in an exhaust of the oven, and adjusting the time and temperature profile based on the humidity content in a closed feedback loop.

One or more embodiments of a method of drying and staining wood may be summarized as including: drying green wood in an oven, including drying the green wood until a moisture content of an outermost surface of the green wood is approximately 15% or less to produce dry surface wood; conveying the dry surface wood from an outlet of the oven directly into a stain booth; applying stain to all sides of the dry surface wood in the stain booth to produce stained wood; allowing the stain to wet out and adsorb onto the surface by transporting the stained wood on a conveyer while conveying the stained wood along the conveyer for approximately 30 seconds to approximately 120 seconds; and bundling the stained wood for shipping at the end of the process.

In an embodiment, the applying of the stain to the dry surface wood further includes conveying the dry surface wood through the stain booth at a rate sufficient to coat the dry surface wood to a predefined aesthetic quality associated with a product code.

In an embodiment, the drying of the green wood includes drying the green wood in the oven according to a time and temperature profile that achieves a sufficient surface moisture content to allow wetting and adsorption of the stain.

The method may further include, before the drying of the green wood: loading bulk green wood onto a tilt table; singulating the bulk green wood into individual pieces of green wood and loading the individual pieces of green wood on a second conveyor; and conveying the individual pieces of green wood from the tilt table to an inlet of the oven with the second conveyor.

In an embodiment, the applying of the stain to the dry surface wood includes pulling excess stain from the dry surface wood in the stain booth downstream of any nozzles or manifolds that might be in the stain booth.

In an embodiment, the moisture content of the outermost surface of the dry surface wood is measured with a pin meter resting under its own weight on the outermost surface of the dry surface wood.

In an embodiment, the drying of the green wood in the oven includes the green wood and the dry surface wood having an internal moisture content of at least approximately 15% before and after the drying, as measured with a pin meter inserted 0.08 inches into the green wood and the dry surface wood, respectively.

One or more embodiments of a wood product may be summarized as including: a piece of wood with an inner portion and an outer portion surrounding the inner portion, the outer portion having an outermost surface; and a stain layer on the outermost surface of the outer portion of the piece of wood, wherein when the stain is applied, the inner portion has an initial moisture content greater than approximately 15% and the outermost surface has a moisture content of less than approximately 15%, and wherein the stain layer is at least semi-permeable and configured to release moisture from the inner portion over time to reduce the moisture content of the inner portion from the initial moisture content to a final moisture content of approximately 15% or less. Namely, The stained board is able to release moisture over time to reduce the internal moisture to a final moisture content of approximately 15% or less even after being stained.

In an embodiment, the piece of wood has a boundary between the inner portion and the outer portion located approximately 0.08 inches from the outermost surface of the piece of wood.

In an embodiment, the initial moisture content and the final moisture content of the inner portion of the piece of wood are measured with a pin meter inserted approximately 0.08 inches into the piece of wood.

In an embodiment, the moisture content of the outermost surface is measured with a pin meter resting under its own weight against the outermost surface of the piece of wood.

In an embodiment, the stain layer is configured to adsorb onto the dry surface wood before the dry surface wood takes in water from both the inner portion of the board and from the surrounding air.

In an embodiment, the piece of wood is a fence board, a fence post, or a fence rail.

Other features and advantages of the present disclosure are provided in more detail below.

### BRIEF DESCRIPTION OF THE SEVERAL VIEWS OF THE DRAWINGS

The present disclosure will be more fully understood by reference to the following figures, where like labels refer to like parts throughout, except as otherwise specified. The figures do not describe every aspect of the teachings disclosed herein and do not limit the scope of the claims.

FIG. 1 is an isometric view of one or more embodiments of a system for drying and staining wood according to the present disclosure.

FIG. 2 is an isometric view of a feed subsystem and a drying oven of the system of FIG. 1.

FIG. 3 is an isometric view of an output from the drying oven and input into stain booth of the system of FIG. 1.

FIG. 4 is an enlarged isometric view of the wood coming out of the staining booth onto the conveying subsystem of the system of FIG. 1.

FIGS. 5A-5C are schematic views of a pin meter measuring moisture content of wood according to embodiments of the disclosure.

FIG. 6 is a block diagram of a controller suitable for executing an embodiment of a system that performs at least some techniques described in the present disclosure, as well as various devices connected thereto.

### DETAILED DESCRIPTION

Persons of ordinary skill in the relevant art will understand that the present disclosure is illustrative only and not in any way limiting. Other embodiments of the presently disclosed systems and methods readily suggest themselves to such skilled persons having the assistance of this disclosure.

Each of the features and teachings disclosed herein can be utilized separately or in conjunction with other features and teachings to provide devices, systems, and methods for drying and staining wood, as well as wood products produced by such devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced, but are not intended to limit the dimensions and the shapes shown in the examples in some embodiments. In some embodiments, the dimensions and the shapes of the components shown in the figures are exactly to scale and intended to limit the dimensions and the shapes of the components.

Although the present disclosure will proceed to describe certain non-limiting examples of drying and staining wood that may be particularly advantageous for production of fence components, such as fence boards, fence posts, and fence rails, it is to be appreciated that the concepts of the disclosure can be applied equally to any type of stained wood and is not limited to fence components. Moreover, the concepts of the disclosure can be implemented outside of the field of drying and staining wood, such as for other processes and systems that involve drying of a material or substrate and application of a coating, such as paint, adhesive, and the like to the substrate. While it is known and common to preheat a substrate before applying a coating to prevent air bubbles, cracking, shock, flash rust, etc. the techniques described herein with respect to use of heating oven to merely surface dry green wood for use in a fence and then immediately applying stain has not previously been performed, as will now be described.

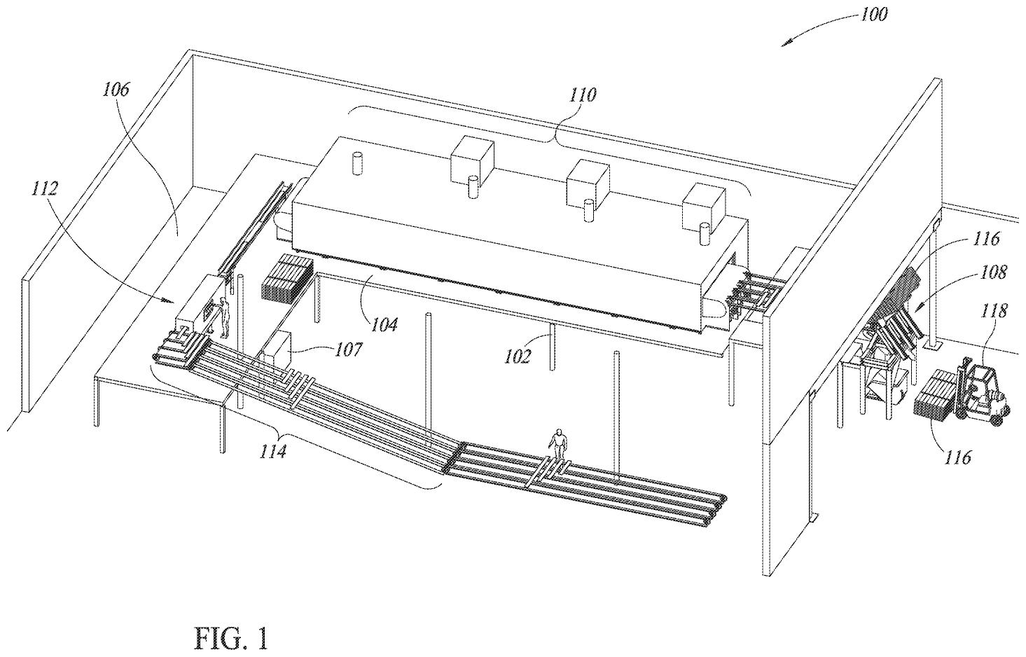

Beginning with FIG. 1, illustrated is a system 100 for drying and staining wood that may be suitable for implementing the methods described herein. The system 100 includes a structural frame 102 supporting a platform 104 above a floor or ground surface 106 in a warehouse, building, or other indoor space. In an embodiment, the platform 104 is omitted and the system 100 may be supported directly on the floor or ground surface 106 with or without a structural frame 102. The system 100 generally includes a feed subsystem 108, an oven 110, a stain booth 112, and a conveying system 114 arranged in sequential order. Each of the feed subsystem 108, oven 110, stain booth 112, and conveying subsystem 114 are positioned on or supported by at least in part, the structural frame 102 and/or the platform 104. For example, the feed subsystem 108, the oven 110, and the stain booth 112 may be positioned on the platform 104 and supported by the structural frame 102 above the floor 106. The conveying subsystem 114 may extend from the platform 112 to the floor 106. Other configurations may be used besides the specific ones illustrated herein. The platform 104 may be positioned directly on the floor or can be vertically spaced from the floor 106 by a selected distance, such as between one foot to twelve feet or more or less, including all intervening values as non-limiting examples. Positioning the platform 104 above the floor 106 may allow for other operations to be carried out underneath the platform 104 and/or for materials to be stored underneath the platform 104, such as a stain storage tank 107. The raised platform 104 may also improve safety by preventing workers or equipment from unintentionally coming into contact with the components of the system 100.

Each of the components of the system 100, namely, the feed subsystem 108, the oven 110, the stain booth 112, and the conveying subsystem 114 will be described in more detail below. In sum, green wood 116 is provided to the feed subsystem 108, such as with a forklift 118 or other machinery. The system 100 may also utilize additional equipment, such as tractors, cranes or forklifts 118 for moving bundles of wood to various locations, but are not illustrated to avoid obscuring the concepts of the disclosure. The feed subsystem 108, in some cases with assistance from an operator, conveys the green wood 116 into the oven 110. The oven 110 is configured to dry the green wood 116 according to a time and temperature profile to produce dry surface wood with a reduced moisture content at an outer surface in a single, continuous processing step. The dry surface wood is provided directly to the stain booth 112, which applies stain to all sides of the dry surface wood. The stained wood exits the stain booth 112 and passes through the conveying subsystem 114 which allows the stain to wet out and adsorb onto the wood. At the end of the conveying subsystem 114, the pre-stained wood can be packaged or bundled for shipping.

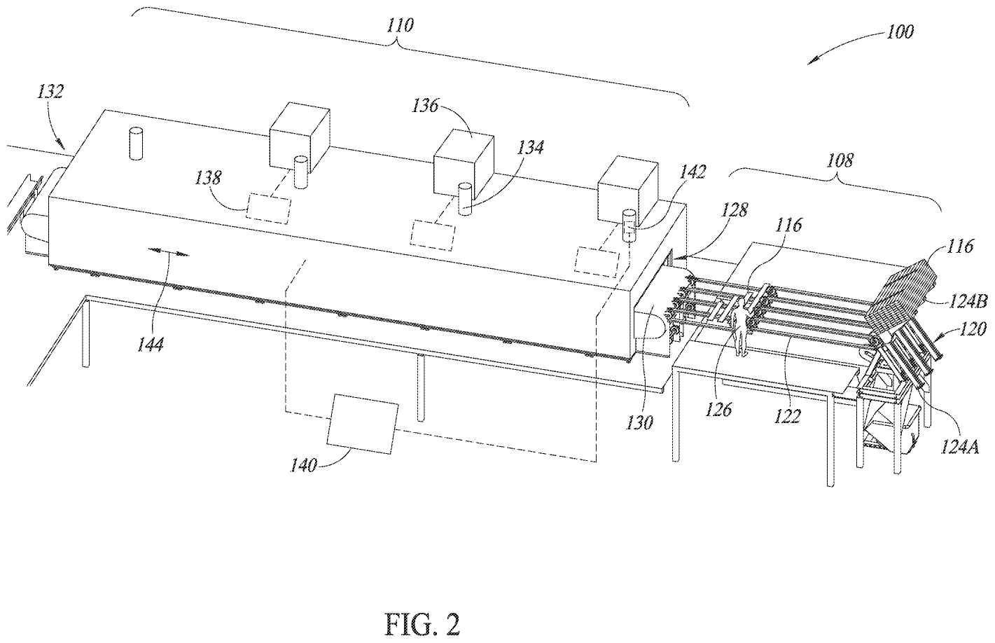

FIG. 2 provides more detail regarding the feed subsystem 108 and the oven 110 of the system 100. The feed subsystem 108 includes a tilt table 120 in communication with a conveyor 122. The tilt table 120 may be a hydraulically and/or electrically actuated assembly for lifting and rotating green wood 116 from a location below the platform 104, such as at the floor 106 or a position above the floor 106 that is accessible by forklift 118, and raising the green wood 116 to a location that is aligned with the conveyor 122 and above the platform 104. In an embodiment, the tilt table 120 may include rotation arms 124A that are rotatable relative a horizontal plane and lift arms 124B that are translatable or movable along a linear path defined by the rotation arms 124A to enable movement of the green wood 116 in at least two degrees of freedom. In some examples, the tilt table 120 may be only a linear or rotational actuator. Once the green wood 116 is aligned with an end of the conveyor 122 by the tilt table 120, as in FIG. 2, an operator 126 may singulate the bulk green wood 116 on the tilt table 120 into individual pieces of green wood 116 on the conveyor 122. The singulation process may be done manually by one or more operators separating the wood into individual pieces spaced from each other or it can be automated in some examples, such as with a pick and place machine or other like mechanical device. The conveyor 122 may be a chain or belt conveyor, among other possibilities and is generally operable to move the singulated green wood 116 from the tilt table 120 to an inlet 128 of the oven 110.

The oven 110 may include a transport device 130, which may be a further conveyor, in communication with the conveyor 122 of the feed subsystem 108 for conveying the green wood 116 through the oven 110 from the inlet 128 to an outlet 132 of the oven 110 in a single, continuous step. The transport device 130 may be driven by a drive system including a motor, gears, belts, sprockets, chains, and the like that are not shown. Further, the transport device 130 may have a conveying speed that is selectable and controllable to vary a residence time of the green wood 116 in the oven 110. In other words, a residence time of the green wood 116 in the oven 110 can be selected and varied by adjusting the speed of the transport device 130. The oven 110 may include one or more exhaust vents 134 and housings 136. The housings 136 may correspond to heating elements 138 internal to the oven 110 and that are illustrated schematically in FIG. 2 with dashed lines. The heating elements 138 may be any commercially available heating element 138 now known or developed in the future, including without limitation, burners (i.e., for propane or natural gas) as well as electric heating elements. The heating elements 138 may operate in isolation to output heat, or may be used in combination with convection fans for heating and circulating hot air inside the oven 110. The exhaust vents 134 may be fluidly connected to an external area outside the building to vent exhaust and other byproducts from the heating operation in the oven 110.

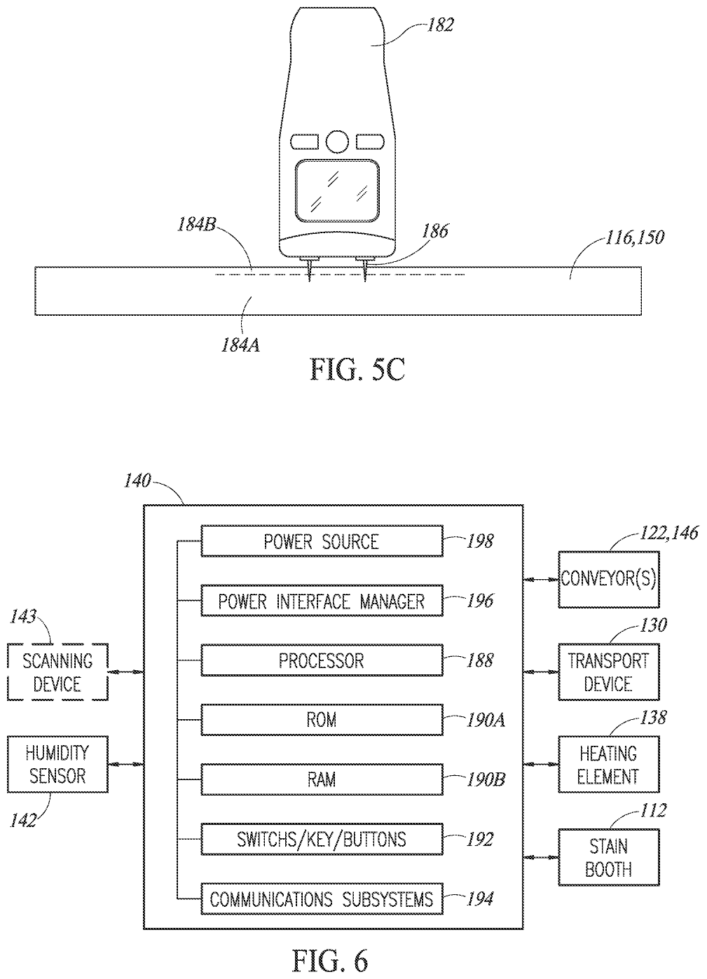

In some embodiments, the oven 110 includes user-actuatable physical controls, such as buttons, switches, and the like for operation of the oven 110 and control of various processing parameters, such as speed of the transport device 130 and temperature output by the heating elements 138. Alternatively, the oven 110 may be associated with a controller 140 that provides instructions for operation of the oven 110 and control of the processing parameters. The controller 140 is described in further detail with reference to FIG. 6. At least one of the exhaust vents 134, such as the exhaust vent 134 located closest to the inlet 128 of the oven 110, may include or be associated with one or more humidity sensors 142 that measure a humidity content of the exhaust through the vent 134. In an embodiment, each exhaust vent 134 includes a respective at least one humidity sensor 142. The humidity content of the exhaust may share a relationship with the moisture content of the green wood 116 (i.e., higher moisture content, higher humidity output in the exhaust and detected by sensor(s) 142) such that the oven 110, via the controller 140, can adjust a time and temperature profile of the green wood 116 through the oven 110 based, at least in part, on the determined humidity content in the exhaust by the humidity sensor(s) 142 in a closed control loop that is described further below. The green wood 116 is dried in the oven according to a selected or determined time and temperature profile that is based on a pre-drying moisture content of the green wood to produce dry surface wood that has a moisture content of less than approximately 15% at the dry surface and is therefore suitable for staining. In one preferred embodiment, it is approximately 12%. If the surface moisture content of the wood is high, the stain may not adequately spread and adsorb onto the surface which could result in uniformity issues, pigment flocculation, and dewetting. This could prevent the finished product from meeting product code or other specifications set in the industry. The time and temperature profile is selected to create a dry surface on the wood that is suitable for staining, but not to completely dry the wood, meaning that the dry surface has a lower moisture content than an internal portion of the wood after the drying, and as further explained below. The inventors have realized that the wood only needs to be dry to under 15% moisture content to a depth in the range of 0.01-0.06 inches. A pin meter resting under its own weight will not penetrate more than 0.06 inches into the surface and will usually penetrate in the range of 0.01 to 0.05 inches. Having a dry surface to the depth of 0.06 inches is sufficient for the stain to uniformly wet and adsorb onto the substrate. Such an arrangement allows for higher throughput and lower cost for drying wood relative to known systems.

The drying of the green wood 116 in the oven 110 according to the concepts of the disclosure is primarily a function of time and temperature, meaning how long the wood 116 remains in the oven 110 and the temperature in the oven 110. A temperature inside the oven 110 may be selected from a temperature in a range between and including 350° degrees and 500° Fahrenheit (“F”), or more or less, including all intervening values, and the green wood 116 may pass through the oven 110 from the inlet 128 to the outlet 132 over a time between and including 30 seconds and 240 seconds, or more or less, and including all intervening values. A temperature in the range of 280° to 450° is preferred and care should be taken to keep it below a temperature that the wood might ignite and thus start on fire. Because the green wood 116 is preferably heated for a comparatively short time (i.e., preferably less than 2 minutes), there are less concerns regarding cracking, warping, igniting or burning the wood. The above times and temperatures generally correspond to a sufficient time and temperature to lower a surface moisture content of the wood 116, as described herein, so the dry surface wood following the drying in the oven 110 is suitable for application of stain. The above drying times and temperatures do not completely dry the wood 116, meaning that after the drying, the internal portion of the wood may have a moisture content that is greater than approximately 15%.

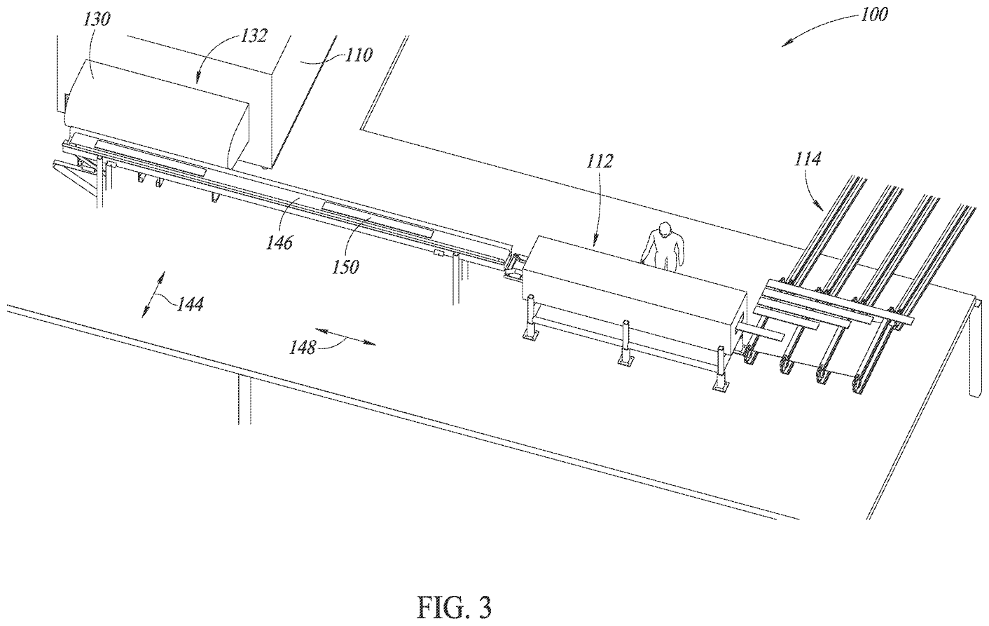

As shown in FIG. 2, the feed subsystem 108 and the oven 110 may generally be arranged in a longitudinal direction indicated by arrows 144, meaning that the feed subsystem 108 and the oven 110 are aligned with each other along a common direction 144. Turning to FIG. 3, the dry surface wood is output to a further conveyor 146 in communication with the oven 110 and the stain booth 112. The further conveyor 146 and the stain booth 112 may be aligned with each other in a lateral direction indicated by arrows 148 that is transverse to the longitudinal direction 144. In an embodiment, the lateral direction 148 is perpendicular to the longitudinal direction 144, meaning that the dry surface wood turns approximately 90 degrees following the oven 110 for further processing at the stain booth 112. The conveying subsystem 114 is likewise positioned along the longitudinal direction 144 in parallel to the oven 110 and feed subsystem 108. Thus, the system 100 has an overall “U” shape or layout that assists with saving space and enabling installation of the system 100 in smaller buildings. The stain booth 112 is configured to apply stain to all sides of the dry surface wood. As shown in FIG. 3, the dry surface wood may be conveyed directly from the outlet 132 of the oven 110 to the stain booth 112 by conveyor 146. The dry surface wood may only reside on the further conveyor 146 for a short time, such as between and including 5-10 seconds or less and up to 90 to 180 seconds in some non-limiting examples, such that there is low time period for the dry surface wood between the oven 110 and the stain booth 112.

In operation, the dry surface wood 150 enters the stain booth 112 via inlet 152 and is conveyed in the lateral direction 148 (FIG. 3) through the stain booth 112 via the appropriate conveyor. The conveyor can be system of rollers that contact the wood on one or more sides, a tray, a belt, or other appropriate conveyor system. The conveying speed through the stain booth 112 may be selected and in some embodiments, controlled by controller 140 (FIG. 1). The dry surface wood 150 is supported underneath the wood 150 by the proper support that also permits staining. The conveyor will move the dry surface wood 150 through stain booth 112 and apply stain from the stain storage tank 107 (FIG. 1). The stain may be a semi-permeable stain available in a variety of colors such that remaining internal moisture in the wood 150 is able to be released from the wood naturally over time. In an embodiment, the dry surface wood 150 is conveyed through the stain booth 112 at a rate sufficient to coat the dry surface wood to a predefined aesthetic quality associated with a product code, meaning application of a color or type of stain in a selected number of coats or layers at a selected conveying speed through the stain booth 112 to produce an aesthetic quality that is consistent with a finished product according to a product code. The staining of the dry surface wood 150 produces stained wood 174 that exits the stain booth 112 at the outlet 154.

The stain booth 112 can be any acceptable stain booth that can evenly apply the proper amount of stain to all sides, (top, bottom, left and right) of the wood in clean manner, of which many are known in the art. Therefore, the stain booth 112 is shown as a generic stain both with dry surface wood 150 entering and properly stained wood 174 coming out.

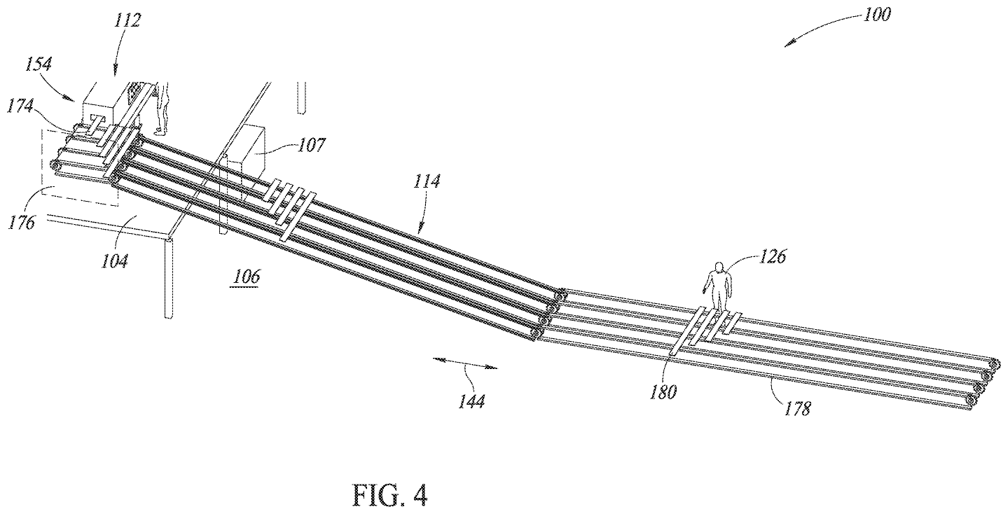

As shown in FIG. 4, the stained wood 174 is provided to a landing area of the conveying subsystem 114 arranged at the outlet 154 of the stain booth 112. The conveying subsystem 114 extends along the longitudinal direction 144 in parallel to the oven 110. Thus, the direction of travel of the stained wood 174 along the conveying subsystem 114 may be perpendicular to a direction of travel through the stain booth 112. In an embodiment, the system 100 includes a backstop 176 that may have an adjustable position to prevent stained wood 174 of different lengths from exiting the landing area and falling off the platform 104. Following the staining at the stain booth 112, the stained wood 174 is conveyed along the conveying subsystem 114. The conveying subsystem 114 may be implemented as a series of sharp chains that have a pointed tip to minimize contact area and avoid marking the stained wood 174 after application, or as some other conveyor device. The conveying subsystem 114 provides a dwelling time to permit the stain to wet out and adsorb onto the surface and allows some cooling if the stain is applied at an elevated temperature. In an embodiment, the conveying subsystem 114 extends from the platform 104 to the ground surface 106 and is therefore arranged at an angle to horizontal (i.e., between and excluding 0 degrees to 90 degrees including all intervening values) that depends on a height of the platform 104 and the length of the conveying subsystem 114. In a non-limiting example, the height of the platform 104 may be about 10 feet and the length of the conveying subsystem 114 can be selected along with a conveying speed of the sharp chains such that a drying time (i.e., a length of time for the stained wood 174 to move from the landing area to the bottom of the conveying subsystem 114) is in the range of approximately 30 seconds to approximately 120 seconds including all intervening values. A time greater than 30 seconds is usually preferred and a longer time, for example, 45 to 90 seconds has been found to be beneficial. The stain continues to wet out and adsorb onto the dry surface wood during cooling along the conveying subsystem 114. The carrier of the stain evaporates over time (which could take one or more months to complete), but due to the green wood being surface dried before the staining, the final appearance of the board remains consistent throughout the evaporation process. Such process may depend, at least in part, on time and temperature with the characteristics (i.e., length, conveying speed, etc.) of the conveying subsystem 114 selected to provide sufficient time for the stain to spread and adsorb onto the substrate. At the end of the conveying subsystem 114 is a grading chain 178 that enables an operator 126 to pull the stained boards 180 and bundle them for shipping.

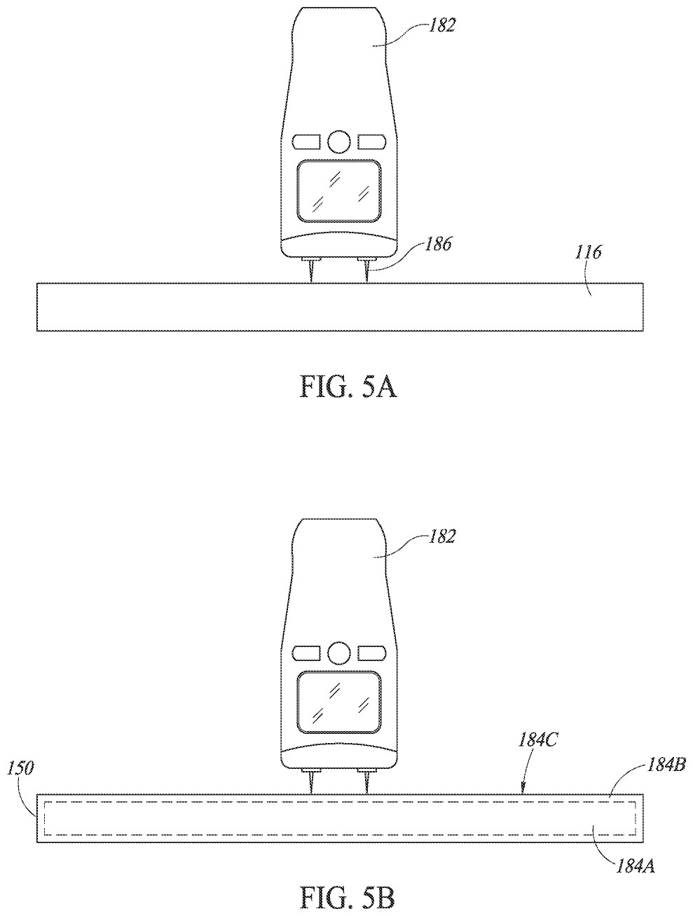

FIGS. 5A-5C are schematic views of a pin meter 182 measuring moisture content of wood according to embodiments of the disclosure. Wood is generally known to have varying characteristics based on a number of factors. For example, the green wood 116 described herein may have an initial surface moisture content and internal moisture content that will vary at least based on a species of the green wood 116 and the ambient humidity of air in which the green wood 116 is stored. The ambient humidity may depend, at least in part, on a location and season where the wood is stored after it was cut as well as the environment that the source trees were cut in. Thus, the initial surface moisture content and internal moisture content of the green wood 116 may vary from 20% to 40% or more or less, and in any event, is likely to be greater than approximately 15%. With reference to FIG. 5A, the moisture content of the outermost surface of the wood (i.e., surface moisture content), such as green wood 116, may be measured with the pin meter 182 resting under its own weight against the outermost surface of the green wood 116. The pin meter 182 may be a commercially available pin meter that typically has a weight less than one pound (16 ounces), and more commonly has a weight less than half of a pound (8 ounces) such that test prongs 186 of the pin meter 182 do not substantially pierce the green wood 116 when the prongs 186 of the pin meter 182 are resting against the surface of the wood 116 under only a weight of the pin meter 182. The depth of the pin might be in the range of 0.01-0.06 inches resting under its own weight and will usually be less than 0.05 inches. The depth is selected to be sufficient for the stain to adequately wet and adsorb onto the substrate and is the depth of the dry surface of the wood that is less than approximately 15%. A higher surface moisture content may interfere with the wetting and adsorption of the stain.

Following the drying of the green wood 116 to produce dry surface wood 150, as in FIG. 5B, the dry surface wood 150 includes an internal portion 184A surrounded by an outer portion 184B. The outer portion 184B may also be described as a dry surface layer 184B around all sides of the inner portion 184A that has an outermost dry surface 184C. In an embodiment, the outer portion 184B or dry surface layer 184B has a thickness or depth into the dry surface wood 150 of approximately less than 0.08 inches. The moisture content of the dry surface 184C can again be measured by the pin meter 182 resting against the outermost surface 184C under its own weight. In some embodiments, the moisture content of the dry surface 184C may be approximately 15% or less following the drying of the green wood 116. Turning to FIG. 5C, the internal moisture content of the wood, such as green wood 116 or dry surface wood 150, can be measured by inserting test prongs 186 of the pin meter 182 into the wood 116, 150, preferably to a depth of approximately 0.08 inches or at least 0.08 inches. At this depth, the prongs 186 extend beyond an interface between the outer portion 184B or dry surface layer 184B and the inner portion 184A that may be located at a depth of less than approximately 0.08 inches into the wood 116, 150 to measure a moisture content of the inner portion 184A. In some embodiments, the moisture content of the inner portion 184B may be higher than the moisture content of the dry surface 184C, such as approximately 15% or more, following the drying. Thus, the wood described herein may have an internal moisture content of at least 15% both before and after the drying.

FIG. 6 is a block diagram of the controller 140. The controller 140 may be suitable for executing or otherwise performing at least some embodiments or techniques described herein with respect to system 100.

The controller 140 includes a processor 188, for example a microprocessor, digital signal processor, programmable gate array (PGA) or application specific integrated circuit (ASIC). The controller 140 includes one or more non-transitory storage mediums, for example read only memory (ROM) 190A, random access memory (RAM) 190B, Flash memory (not shown), or other physical computer- or processor-readable storage media in communication with the processor 188. The non-transitory storage mediums may store instructions and/or data used by the processor 188 and the controller 140 generally, for example an operating system (OS) and/or applications. The instructions as executed by the processor 140 may execute logic to perform the functionality of the various implementations or techniques of the devices and systems described herein.

The controller 140 may include a user interface 192 to allow a worker or other user to operate or otherwise provide input to the system 100 described herein, regarding the operational state or condition of the system 100. The user interface 192 may include a number of user actuatable controls, such as toggle switches, a keypad or keyboard, rocker switches or other physical actuators operable to turn the system 100 ON and OFF and/or to set various operating parameters of the system 100, such global throughput, temperature in the oven 110, and others described herein. In some embodiments, the user interface 192 may include a display, for instance a touch panel display. The touch panel display (e.g., LCD or LED with touch sensitive overlay) may provide both an input and an output interface for the worker or other user. The touch panel display may present a graphical user interface, with various user selectable icons, menus, check boxes, dialog boxes, and other components and elements selectable by the end user to set operational states or conditions of the system 100. The user interface 192 may also include one or more auditory transducers, for example one or more speakers and/or microphones. Such may allow audible alert notifications or signals to be provided to a worker or other user as a result of manual interaction with the user interface 192. Such may additionally, or alternatively, allow a worker or other user to provide audible commands or instructions. The user interface 192 may include additional components and/or different components than those illustrated or described, and/or may omit some components.

The controller 140 includes a communications sub-system 194 that may include one or more communications modules or components which facilitate communications with various components of one or more external devices, such as a personal computing device, mobile device, or server, among others. The communications sub-system 194 may provide wireless or wired communications to the one or more external devices and may include wireless receivers, wireless transmitters and/or wireless transceivers to provide wireless signal paths to the various remote components or systems of the one or more paired devices. The communications sub-system 194 may, for example, include components enabling short range (e.g., via Bluetooth®, BLE (“Bluetooth® low energy”), near field communication (NFC), or radio frequency identification (RFID) components and protocols) or longer range wireless communications (e.g., over a wireless LAN, Low-Power-Wide-Area Network (LPWAN), satellite, or cellular network) and may include one or more modems or one or more Ethernet or other types of communications cards or components for doing so. The communications sub-system 194 may include one or more bridges or routers suitable to handle network traffic including switched packet type communications protocols (TCP/IP), Ethernet or other networking protocols.

The controller 140 further includes a power interface manager 196 that manages supply of power from a power source 198 to the various components of the controller 140 and the system 100. The power interface manager 196 is coupled to the processor 188 and the power source 198. Alternatively, in some implementations, the power interface manager 196 can be integrated in the processor 188. The power source 198 may include an external power supply, or a rechargeable or replaceable battery power supply, among others. The power interface manager 196 may include power converters, rectifiers, buses, gates, circuitry, etc. in some embodiments. In particular, the power interface manager 196 can control, limit, and/or restrict the supply of power from the power source 198 based on the various operational states of the system 100, as described in more detail below.

In some embodiments or implementations, the instructions and/or data stored on the non-transitory storage mediums that may be used by the processor 188 and the controller 140 generally, such as, for example, ROM 190A, RAM 190B and Flash memory (not shown), includes or provides an application program interface (“API”) that provides programmatic access to one or more functions of the controller 140. For example, such an API may provide a programmatic interface to control one or more operational characteristics of the system 100. In this manner, the API may facilitate the development of third-party software, such as various different user interfaces and control systems for other devices, plug-ins, and adapters, and the like to facilitate interactivity and customization of the operation of the system 100.

In an embodiment, components or modules of the controller 140 and other devices within the system 100 described herein are implemented using standard programming techniques. For example, the logic to perform the functionality of the various embodiments or techniques described herein may be implemented as a “native” executable running on the controller 140, e.g., microprocessor 188, along with one or more static or dynamic libraries. In other embodiments, various functions of the controller 140 may be implemented as instructions processed by a virtual machine that executes as one or more programs whose instructions are stored on ROM 190A and/or RAM 190B. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the controller 140, such as microprocessor 188, to perform the functions of the controller 140. The instructions cause the microprocessor 188 or some other processor, such as an I/O controller/processor, to process and act on information received from one or more sensors or other external devices to provide the functionality and techniques of the system 100 described herein.

The embodiments or implementations described above may also use well-known or other synchronous or asynchronous client-server computing techniques. However, the various components may be implemented using more monolithic programming techniques as well, for example, as an executable running on a single microprocessor, or alternatively decomposed using a variety of structuring techniques known in the art, including but not limited to, multiprogramming, multithreading, client-server, or peer-to-peer (e.g., Bluetooth®, NFC or RFID wireless technology, mesh networks, etc.), running on one or more computer systems each having one or more central processing units (CPUs) or other processors. Some embodiments may execute concurrently and asynchronously, and communicate using message passing techniques. Also, other functions could be implemented and/or performed by each component/module, and in different orders, and by different components/modules, yet still achieve the functions of the controller 140.

In addition, programming interfaces to the data stored on and functionality provided by the controller 140, can be available by standard mechanisms such as through C, C++, C#, and Java APIs; libraries for accessing files, databases, or other data repositories; scripting languages; or Web servers, FTP servers, or other types of servers providing access to stored data. The data stored and utilized by the controller 140 and overall system 100 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible.

Furthermore, in some embodiments or implementations, some or all of the components of the controller 140 and components or other devices of the system 100 may be implemented or provided in other manners, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques. In some non-limiting examples, the techniques of the controller 140 described herein may be implemented with control software and/or control logic, such as from Contrologix, in conjunction with control hardware, such as from Allen Bradley.

In an embodiment, the controller 140 is in communication with at least the conveyor 122 of the feed subsystem 108, the transport device 130 of the oven 110, the heating elements 138 of the oven 110, the further conveyor 146 between the oven 110 and the stain booth 112, the stain booth 112, and the humidity sensor 142 associated with at least one of the exhaust vents 134. The non-transitory storage medium, such as at least ROM 190A and/or RAM 190B may store instructions, that when executed by the processor 188, control a conveying speed of the conveyors 122, 146, the transport device 130, and the throughput through the stain booth 112. The conveying speed may be adjustable and selectable to vary throughput through the system 100 generally, as well as throughput in individual aspects of the system 100. For example, because the throughput through the oven 110 via transport device 130 is independent of throughput through the stain booth 112, the conveying speed of the transport device 130 may be selected to be different than the conveying speed through the stain booth 112 via the appropriate conveyor system via input to user interface 192 and corresponding instructions stored in the storage medium and executed by the processor 188.

The non-transitory storage medium, such as at least ROM 190A and/or RAM 190B may store further instructions, that when executed by the processor 188, control a time and temperature profile through the oven 110 based on information, data, and/or signals received from the humidity sensor 142. In more detail, the humidity sensor 142 may provide information, data, and/or signals to the controller 140 corresponding to a determined humidity level in at least one exhaust vent 134 of the oven 110. The controller 140 may receive such information, data, and/or signals and compare the same to a database of time and temperature profiles for different detected humidity concentrations to determine whether to execute further instructions to adjust the residence time of the wood in the oven 110 (i.e., conveying speed of transport device 130) and/or the temperature of the oven 110 (i.e., fuel and/or power provided to heating elements 138) in a closed feedback loop.

In a non-limiting example, the oven 110 may initially be operating at a temperature of 350 degrees F. with the transport device conveying the green wood 116 through the oven 110 for a time of 100 seconds according to a time and temperature profile for a first humidity detected by the humidity sensor 142. If the humidity sensor 142 detects a change in humidity that is greater than a defined error threshold, such as more than a 2% change in humidity, among many other possibilities, the controller 140 may execute instructions to compare the second, different humidity to the database of time and temperature profiles and select a new time and temperature profile corresponding to the second humidity. The controller 140 then executes further instructions to change the conveying speed of the transport device 130 and/or to change the temperature in the oven 110 according to the second time and temperature profile in a closed feedback loop. The second time and temperature profile may be, for example, a temperature of 400 degrees F. and a time through the oven 110 of 90 seconds or a change in only the temperature to 400 degrees F. with the time through the oven 110 remaining the same at 100 seconds. The time and temperature profiles described herein may generally correspond to any selected value in the ranges provided herein, including a time through the oven 110 between 30 seconds and 240 seconds at a temperature between 350 degrees F. to in the range of 450 to 500 degrees F. The time and temperature profiles may be developed, at least in part, based on known or experimental data for achieving a sufficient surface moisture content of the dry surface wood 150 following the drying to allow wetting and adsorption of the stain onto the surface, accounting for different species, ambient humidities, and pre-drying moisture contents of the green wood 116. In an embodiment, the sufficient surface moisture content corresponds to the moisture content at the outermost surface 184C (FIG. 5B) of the dry surface wood 150 of approximately 15% or less.

In an embodiment, the humidity sensor 142 is optionally supplemented by, or replaced with, a scanning device 143, such as a line scanning device, positioned proximate inlet 128 of the oven 110 and that includes infrared or near-infrared emitters and/or sensors for determining a moisture content of the green wood 116 entering the oven 110 and provides the same to the controller 140 in a closed feedback loop of the type described above. In other words, the information, data, and/or signals from the humidity sensor 142 can be supplemented with, or optionally replaced by, information data, and/or signals from the scanning device 143 to provide the closed feedback loop described above in some embodiments.

Many other variations are contemplated herein, including without limitation, using higher temperatures than those described above for shorter or longer periods of time, and using the temperatures mentioned above for shorter or longer periods of time. As noted above, the initial surface moisture content may be determined by pin meter 182 or any other acceptable technique that is known to be accurate. A time and temperature profile can then be selected for wood with varying moisture contents to produce dry surface wood 150 with a surface moisture content that is suitable for application of stain, or approximately 15%.

It should also be appreciated that the above description of the system 100 includes related methods. A non-limiting example of a method might include drying green wood 116 in the oven 110 according to a time and temperature profile until a moisture content of an outermost surface of the green wood 116 is approximately 15% or less to produce the dry surface wood 150. The method further includes conveying the dry surface wood 150 from the outlet 132 of the oven 110 and directly to the stain booth 112 via conveyor 146. The stain booth 112 applies stain to all sides of the dry surface wood 150 to produce stained wood 174. The stained wood 174 is conveyed along the conveying subsystem 114, which may be a conveyor, over a time period that may vary, but is preferably between approximately 30 seconds to 120 seconds. After the conveying period, the stained wood 180 can be bundled for shipping by an operator 126. Methods also include varying the characteristics of the oven 110 (i.e., at least the conveying speed of transport device 130 and temperature in the oven 110 via heating elements 138) in a closed feedback loop to dry wood with varying initial moisture content based on information received from humidity sensors 142 and/or scanning device 143, among others.

Thus, the concepts of the disclosure provide for systems, devices, and methods for drying and staining wood, as well as stained wood produced by such systems, devices, and methods, that can be produced at a lower overall cost than with known technologies. The concepts of the disclosure generally consider drying wood for only a comparatively short time to form a dry surface layer that reduces drying time relative to known technologies, yet allows the stain to be applied on the dry surface layer and to spread and adsorb onto the substrate. The remaining moisture in the wood is released from the board over time, even after the pre-stained wood is installed in its final location by the end user. The feedback control loop described herein assists with varying the characteristics of the oven to produce consistent results for wood of varying initial moisture content.

In the above description, certain specific details are set forth in order to provide a thorough understanding of various embodiments of the disclosure. However, one skilled in the art will understand that the disclosure may be practiced without these specific details. In other instances, well-known structures associated with the technology have not been described in detail to avoid unnecessarily obscuring the descriptions of the embodiments of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other derivatives thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise.

Generally, unless otherwise indicated, the materials for making the invention and/or its components may be selected from appropriate materials such as composite materials, ceramics, metal, various polymers, (e.g. thermoplastics, elastomers, plastic compounds), catalysts and ammonia compounds, and the like, either alone or in any combination.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the embodiments of the disclosure can be arranged in any orientation.

Unless the context clearly dictates otherwise, relative terms such as “approximately,” “substantially,” and other derivatives, when used to describe a value, amount, quantity, or dimension, are generally construed to include an ordinary error range or manufacturing tolerance and generally refer to a value, amount, quantity, or dimension that is within plus or minus 3% of the stated value, amount, quantity, or dimension. It is to be further understood that any specific dimensions of components or features provided herein are for illustrative purposes only with reference to the various embodiments described herein, and as such, it is expressly contemplated in the present disclosure to include dimensions that are more or less than the dimensions stated, unless the context clearly dictates otherwise.

The present application claims priority to U.S. Provisional Application No. 63/506,008 filed on Jun. 2, 2023 in the United States Patent Office, the entire contents and disclosure of which are incorporated herein by reference.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of drying and staining wood, comprising:
feeding green wood with a varying moisture content over 20% into an oven;
drying the green wood in the oven according to a time and temperature profile that is based on a pre-drying surface moisture content of the green wood to produce dry surface wood having a surface moisture content of less than approximately 15% at the surface; and
staining the dry surface wood immediately following the drying.

2. The method of claim 1, wherein the drying of the green wood is a single, continuous processing step.

3. The method of claim 1, wherein the time and temperature profile varies depending on one or more of a species of the green wood, ambient humidity in which the green wood has been stored and the pre-drying moisture content of the green wood entering the oven.

4. The method of claim 1, wherein the moisture content of the dry surface wood is measured at an outermost surface of the dry surface wood.

5. The method of claim 4, wherein the moisture content at the outermost surface of the dry surface wood is measured with a pin meter resting under its own weight on the outermost surface of the dry surface wood.

6. The method of claim 1, wherein an internal moisture content of the dry surface wood is greater than approximately 15% after the drying, as measured by a pin meter inserted at least 0.08 inches into the wood.

7. The method of claim 1, wherein the drying of the green wood includes determining the pre-drying moisture content of the green wood based on a humidity content in an exhaust of the oven, and adjusting the time and temperature profile based on the humidity content in a closed feedback loop.

8. A method of drying and staining wood, comprising:
drying green wood in an oven, including drying the green wood until a moisture content of an outermost surface of the green wood is approximately 15% or less to produce dry surface wood;
conveying the dry surface wood from an outlet of the oven directly into a stain booth;
applying stain to all sides of the dry surface wood in the stain booth to produce stained wood;
exposing the stained wood to ambient air for a selected dwelling time on a first conveyer while conveying the stained wood along the first conveyer, the dwelling time being in the range of approximately 30 seconds to approximately 120 seconds; and
bundling the stained wood for shipping after the conveying.

9. The method of claim 8, wherein the applying of the stain to the dry surface wood includes:
conveying the dry surface wood through the stain booth at a rate sufficient to coat the dry surface wood to a predefined aesthetic quality associated with a product code.

10. The method of claim 8, wherein the drying of the green wood includes drying the green wood in the oven according to a time and temperature profile that achieves a sufficient surface moisture content to allow wetting and adsorption of the stain onto the surface.

11. The method of claim 8, further comprising, before the drying of the green wood:
loading bulk green wood onto a tilt table;
singulating the bulk green wood into individual pieces of green wood and loading the individual pieces of green wood on a second conveyor; and
conveying the individual pieces of green wood from the tilt table to an inlet of the oven with the second conveyor.

12. The method of claim 8, wherein the applying of the stain to the dry surface wood includes pulling excess stain from the dry surface wood in the stain booth.

13. The method of claim 8, wherein the moisture content of the outermost surface of the dry surface wood is measured with a pin meter resting under its own weight on the outermost surface of the dry surface wood.

14. The method of claim 8, wherein the drying of the green wood in the oven includes the green wood and the dry surface wood having an internal moisture content of at least approximately 15% before and after the drying, as measured with a pin meter inserted 0.08 inches into the green wood and the dry surface wood, respectively.

15. A wood product, comprising:
a piece of wood with an inner portion and an outer portion surrounding the inner portion, the outer portion having an outermost surface; and
a stain layer on the outermost surface of the outer portion of the piece of wood,
wherein when the stain is applied, the inner portion has an initial moisture content greater than approximately 15% and the outermost surface has a moisture content of less than approximately 15%, and
wherein the stain layer is semi-permeable and configured to release moisture from the inner portion over time to reduce the moisture content of the inner portion from the initial moisture content to a final total moisture content of approximately 15% or less.

16. The wood product of claim 15, wherein the piece of wood has a boundary between the inner portion and the outer portion located approximately 0.08 inches from the outermost surface of the piece of wood.

17. The wood product of claim 15, wherein the initial moisture content and the final moisture content of the inner portion of the piece of wood are measured with a pin meter inserted approximately 0.08 inches into the piece of wood.

18. The wood product of claim 15, wherein the moisture content of the outermost surface is measured with a pin meter resting under its own weight against the outermost surface of the piece of wood.

19. The wood product of claim 15, wherein the stain layer is configured to spread and adsorb onto the dry surface wood before the dry surface wood takes in moisture from both the interior of the board and from the surrounding air.

20. The device of claim 15, wherein the piece of wood is a fence board, a fence post, or a fence rail.
